(19) United States
(12) Patent Application Publication
(10) Pub. No.: US 2009/0211894 A1
(43) Pub. Date: Aug. 27, 2009

(54) Continuous and Semi-Continuous Treatment of Textile Materials Integrating Corona Discharge

(76) Inventors: Noemia Maria Ribeiro De Almeida Carneiro Pacheco, Guimaraes (PT); Antonio Pedro Garcia De Valadares Souto, Fafe (PT); Eckhard Prinz, Hamburg (DE); Frank Förster, Hamburg (DE)

Correspondence Address: Pearl Cohen Zedek Latzer, LLP, 1500 Broadway, 12th Floor, New York, NY, 10036, US

(21) Appl. No.: 11/597,102

(22) PCT Filed: May 20, 2004
(86) PCT No.: PCT/PT2004/000008

§ 371 Date: Apr. 22, 2008

(51) Int. Cl. H05F 3/00; D06M 10/02; B01J 19/08

(52) U.S. Cl. 204/165; 422/186.05

(57) ABSTRACT

The application of CORONA discharge is proposed in continuous and semi-continuous processes for the finishing of cotton, flax, cotton/flax blends or other cellulosic materials, either in form of yarns, woven or knitted fabrics, in order to obtain complete hidrophilization and an increase of reticulation potential. The goal is to achieve easier and uniform wetting and impregnation with treatment products and an improved adhesion of resins and binders. The operations where CORONA discharge is included are desizing, alkaline treatment, bleaching, caustification, mercerization, dyeing, printing and final finishing treatments, namely softening, hydrophilization, easy-care, anti-shrinkage and fireproofing. Discharge is continuously applied in open width materials with controlled humidity and temperature, in the stages of raw, desized, bleached or finished. The materials moves with controllable velocity on a counter-electrode roll positioned at a small distance of an electrode, which is designed to produce a high voltage discharge in completely uniform conditions.

Impregnation processes are very exigent in what concerns uniformity of the materials. Any deficiency at this level creates irreparable damages in the quality of the products obtained.

All cellulosic fibers are hydrophobic in raw stage, especially because a large amount of impurities form a barrier to the aqueous bath, preventing penetration and diffusion into the fiber structure. The impregnation of this type of fabrics, during treatment processes in continuous and semi-continuous, demand a high and completely uniform capability concerning bath absorption, to get an optimal yield and homogeneous results in preparation, dyeing, printing and final finishing. Due to natural hydrophobicity, these exigencies are very difficult to accomplish. In practice the elimination of this technical problem obligates to use several wetting agents, to reduce the velocity of materials or to increase impregnation's bath temperature. The most important consequences of these practical procedures are:
The use of wetting agents in recipes of impregnation baths means an increase of costs, increase of pollution discharges and problems with formation of foam;
The decrease of velocity implicates a decrease of production levels;
The increase of bath temperature means higher energetic costs and can contribute to the formation of aggregates of products present in the impregnation bath.

The benefits of previous uniform hidrophilization of cellulosic materials which will be impregnated in a foulard are considered of fundamental importance and are the basic support of the introduction of CORONA plasmatic technology, able to modify the surface of the materials in controlled conditions in order to achieve a very positive behavior during impregnation.

In CORONA treatment, an electrical discharge is produced between an electrode and a counter-electrode turned on earth, keeping a difference of potential around 10000 volts. Fabric move continuously between the electrodes with controllable velocity and adequate tension.

Material's temperature and humidity are defined in order to optimize the discharge effect. Cotton temperature must be set under 40° C. and humidity rate under 8%. Discharge is made in air at ambience pressure and temperature.

The main cellulosic fibers that are submitted to CORONA discharge are cotton, flax, hemp and blends with synthetic and artificial fibers if cellulosic are present in higher percentage. A large number of other cellulosic fibers, less used in textile industry, can also be treated using this technology.

### DOMAIN OF THE INVENTION

The present invention concerns integration of the CORONA discharge in continuous and semi-continuous lines for the treatment of cellulosic materials in order to get hidrophilization and increase of reticulation potential.

The operations directly influenced by physical and chemical alterations induced by plasmatic discharge in the structure of textile materials are desizing, alkaline treatment, bleaching, caustification, mercerization, dyeing, printing and finishing.

CORONA discharge is made in air at normal atmospheric conditions, with continuous movement of the textile material.

### EVALUATION OF THE STATE OF THE ART

A CORONA discharge is produced between two electrodes, in conditions of high voltage and frequency of 20-40 KHz at ambience pressure and temperature.

This technology has a wide application in plastics industry, in order to increase adhesion between impression links and substrates, and is perfectly consolidated in this sector. In plastics polymeric films, processing velocities of the material can be as high as 450 m/min, with widths going up to 10 m and excellent uniformity of treatment. As an example, the American patent No. 5882423 “Plasma cleaning method for improved ink brand permanency on IC packages” describes a process that uses plasma to achieve decontamination of metallic, ceramic, plastic components of integrated circuits, obtaining higher surface energies, which allow a better ink adhesion to the materials.

If the discharge is made at low pressure (1-100 mbar) with a voltage of 400-800 V and a frequency range from 1 MHz to 2.1 GHz the treatment is denominated “plasma” or “Glow discharge” being a particular case of plasma medium. This particular treatment is already known in textile industry and gives the possibility to work with several gaseous mediums and pressure levels in order to obtain distinct results. It is used to improve shrink resistance, hidrophilicity and spin ability of wool fibers, but it is very expensive and obliges to work in vacuum in its classical version [1], [2], [3].

Also concerning wool fibers, CORONA technology is used in processes to improve dyeing and to obtain anti-felting properties. European patent No. EP0548013, “Process for dyeing of wool with help of low-temperature plasma or Corona pre-treatment” describes a process which includes a superficial CORONA pre-treatment followed by dyeing in aqueous bath without leveling agents and avoiding the final treatment with chlorine. Concerning anti-felting properties, the American patent No. 6103068, “Process for anti-felting finishing of wool using a low-temperature plasma treatment” describes a process to confer anti-felting finishing to wool by a treatment with a high frequency low temperature plasmatic discharge.

CORONA treatment is also used to improve adhesion in coated textiles. European patent No. GB2279272 “Process for coating textile fabrics with elastomers” describes the increase of the adhesion of a silicon layer to the textile fabric in coated materials by application of a CORONA discharge.

### BRIEF DESCRIPTION OF THE DRAWINGS

FIG. 1 represents the absorption time of a drop of water by a cotton fabric according to the number of CORONA discharges for different power levels;

FIG. 2 represents the dynamometric resistance of the warp of a cotton fabric according to the number of CORONA discharges;

FIG. 3 represents the absorption time of a drop of water by a linen fabric according to the number of CORONA discharges;

FIG. 4 represents a CORONA discharge applicator for textile materials.

### DETAILED DESCRIPTION OF THE INVENTION

New non-pollutant technologies are essentially based in physical means of production of plasmas, either at low pressure, or at ambience conditions, as in the case of CORONA. These techniques are optimal solutions to design cleaner and cheaper processes, as well as final products of higher quality and are considered unique opportunities for the adoption of processes ecologically convenient at interesting costs.

The traditional textile industry is considered as still not being competitive enough and rapid and innovative solutions are needed in order to help resolve this limitation. The application of CORONA technology in this field was therefore analysed in view of the fact that it the simplest option, as it allows for the possibility of working continuously and semi-continuously, with proven advantages in terms of the efficacy of the processes.

The application of CORONA technology in textile materials, namely cellulosic puts specific problems concerning high energetic demands, but has been thought as a very convenient solution for continuous and semi-continuous processes, running at velocities as high as 60 m/min for maximum fabrics width of 3.60 m.

The development of new solutions for the integration of CORONA technology in the processing of textile materials has been accomplished by the University of Minho and associated partnership in order to take maximum advantage of the up-grade in hidrophilicity, uniformity and surface reactivity.

The construction of a laboratorial prototype of CORONA discharge, with a system of ceramic electrode and a role counter-electrode and continuous movement of the fabric, has given the possibility to study the scientific basis for correct system analysis, as well as to evaluate practical benefits, economical and ecological advantages coming up of the new processes. Discharge is produced between the electrodes maintaining a difference in electric potential around 10 000 volts. Temperature and humidity of the material were defined in order to optimise discharge effects and to prevent damage in fabrics, this is, a temperature under 40° C. and humidity less than 8% for cotton fabrics.

After CORONA treatment, an increase in superficial roughness of cotton fiber is detected, due to a “cleaning effect”, with creation of channels, which contribute to influence positively the access of baths and products inside the fiber.

In chemical terms, CORONA treatment is responsible by a surface oxidation affecting the behaviour of materials during industrial processing. Non-treated cotton has an average atomic composition of 82.9% for carbon and 14.7% for oxygen, being also detected low levels of magnesium, potassium and sodium. After CORONA treatment a reduction in carbon concentration to 57.8% is detected, as well as a strong increase of oxygen up to 37.3%. These values are very close to the ones presented by pure cellulose. Groups as C—O, OCO and COOR increase significantly, showing that accessibility into cellulose situated under waxy cuticle becomes easier and effective.

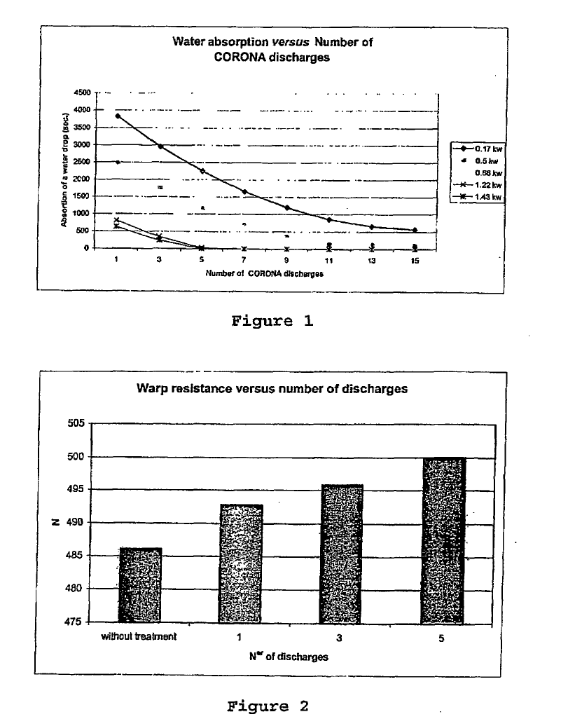

A model has been constructed for cotton fabric's behaviour, representing the relation between hidrophility obtained after treatment and discharge conditions as power of discharge, number of discharges and velocity of the fabric. An example is presented in FIG. 1. Using these variables and for a given treatment width, CORONA dosage is calculated and compared for different practical situations.

For increasing number of CORONA passages, mechanical resistance of raw cotton fabric has been tested and higher values are obtained (FIG. 2).

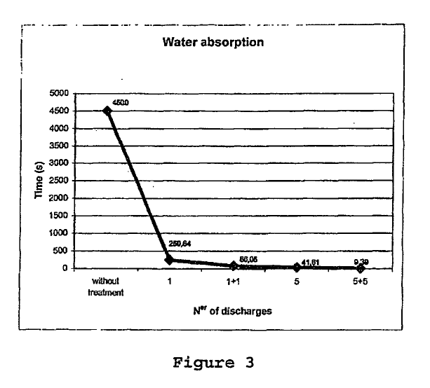

Variation of hidrophility with number of CORONA discharges in the case of hydrophobic linen fabrics is represented in FIG. 3, and similar variation has been found when compared with cotton behaviour.

It has been proved that discharge is able to produce physical and chemical effects in the surface which are responsible by hydrophilisation and reactivity increase, namely in the operations of desizing, alkaline treatments, mercerisation, dyeing, finishing and printing, specially when the processes are continuous and semi-continuous [4], [5], [6], [7].

Very promising results were obtained when discharged raw or desized cotton fabrics are mercerised without any type of wetting agent, obtaining higher levels of efficacy and uniformity, with increases in the number of barium going up to 60% when compared to non coronised fabrics. This result will be applied to flax/cotton blends and even to 100% linen products.

Concerning the behaviour of fabrics during impregnation by padding with dyeing and finishing baths in continuous and semi-continuous processes, it is possible to get higher pick-up and uniformity, even without wetting agent, which means better final results in a more economical and ecological way.

In general, uniform CORONA discharge in cotton and flax materials is obtained using energetic levels perfectly adapted to industrial implementation in several phases of the processing.

### DESCRIPTION AND REALISATION OF THE INVENTION

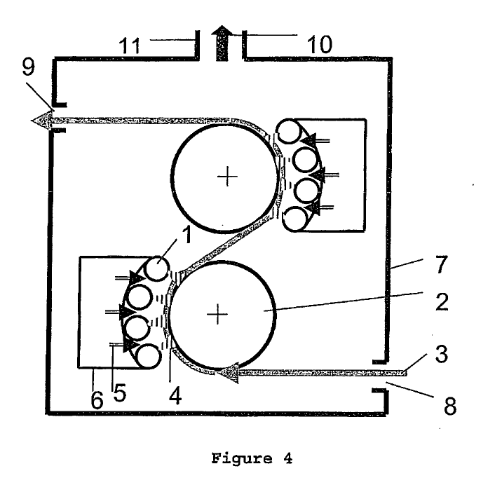

The principle of the corona treater for textile web is presented in the illustrative FIG. 4. Main components are the electrode with several electrode bars (1) and counter electrode (2), which is preferably a moving counter electrode supporting the moving textile web (3). Sufficient sinusoidal or pulsed voltage of 5000 to 30000 volts, preferable 10000-15000 volts and frequency of 10 to 100 kHz, preferable about 30 kHz, are applied to the electrode bars (1) to create and maintain the CORONA discharge (4) within the gap in between electrode bars (1) and counter electrode (2). The counter electrode (2) is connected to earth potential. The process takes place at normal atmospheric pressure. The CORONA discharge (4) improves hydrophilisation and reticulation potential of textile materials.

The electrode consists of several electrode bars (1) with dielectric (not shown in FIG. 4), preferable ceramic, and are set at distance of preferable 1.5 mm to the counter electrode (2). For cooling of electrode gaseous medium (5), preferable air, is injected in between the electrode bars (1). Gas distribution chamber (6) with slots sustains equal gas flow along width of the electrode bars (1).

The electrode consisting of electrode bars (1) and gas distribution chamber (6) and the counter electrode (2) are surrounded by housing (7). Housing has an inlet (8) and outlet (9) for the textile web (3). Off-gas (9) containing ozone and other gaseous components are sucked off via hose (10) by a fan, which is not shown in FIG. 4.

The gap between electrode bars (1) and counter electrode (2) is at least 0.8 mm, preferable 1.5 mm and not more than 3 mm. The gap is set by moving either the electrode consisting of electrode bars (1) and gas distribution camber (6) or counter electrode (2).

The counter electrode (2) is preferably a rotating drum coated with a dielectric (not shown in FIG. 4), preferable silicon or ceramic and is transporting the textile web (3). Movement of the textile web (3) takes place at a controlled velocity. For temperature control, counter electrode (2) has form of double skin drum and can either be heated or preferably be cooled with gaseous or preferable liquid medium.

According to velocity of the textile web (3) several units consisting of electrode and counter electrode (2) are used for treatment of textile web (3). These units allow either single or double side treatment of textile web (3).

Wet processing of cellulosic fabrics involves several stages, namely:
Preparation in which cleaning, hidrophilization, dimensional stabilisation and bleaching are the main goals;
Dyeing in which dyes are applied and fixed;
Printing in which printing pastes or inks are applied and fixed and
Final finishing in which a wide range of properties are improved by application of specific products and treatments.

CORONA integration in the lines of wet processing of cellulosic materials is proposed and the following options are proposed:
CORONA discharge is applied before enzymatic desizing.
This operation will benefit, because fabric becomes hydrophilic even without wetting agent in the impregnation bath used for padding in continuous and semi-continuous processes. More uniform results are guaranteed, concerning sizing agent removal with deeper action over the warp yarn. Inactivation of enzymes by tensoactives is avoided.

If desizing is done by solubilization in water, swelling of the sizing agent is shortened and facilitated.
CORONA discharge can replace scouring.
In processing lines that include independent scouring treatments, this operation aims hidrophilization by removal of waxes and fatty matters. If a CORONA discharge is applied in grey materials, penetration of baths can be achieved minimising the use of chemical products. Removal of natural impurities is possible in further oxidative/alkaline bleaching treatments.
CORONA discharge is applied as a pre-treatment of caustification or mercerisation.
These operations use highly concentrated alkaline baths, applied in continuous to raw, desized or half-bleached materials during short contact times. If a CORONA discharge is previously made, the problem of lack of penetration of the bath into the fabric and fibres is overcome. This is especially important if the material is still hydrophobic in a non-swollen state, much more favourable to increase mercerisation effects. The use of wetting agents in order to promote contact and penetration of the bath into the fabric is possible and current practice, but important problems of adequate choice concerning chemical resistance to alkalis and effluent's recovery can be solved using CORONA.

Previous hidrophilization of the fabrics by the use a CORONA discharge is also responsible for significantly higher percentage of mercerised fibres, which means higher final quality at lower costs and less environmental problems.
CORONA discharge can be applied to flax, hemp and blends.
In the particular case of the preparation of linen fabrics and hemp materials, difficulties in the penetration of the bath are higher, due to the more crystalline structure, when compared with cotton fibre, and to the presence of a higher level of natural impurities. CORONA discharge over linen materials confers hidrophilization without the use of chemicals.
CORONA discharge assures uniformity and higher pick-up in padding processes.
With a discharge previous to padding in pad-batch, pad-roll or pad-steam processes used to dye cellulosic fabrics it is possible to impregnate fabrics, in a completely uniform way, without wetting agent, even if the materials have a deficient preparation, in some cases considered as enough to dye in dark colours. Higher penetration of the dye in fibres is achieved, meaning an increase of irreversibility of the dyeing process.
CORONA discharge increases fixation of resins and binders in final finishing and printing processes.

The increase of the reactive potential of the surface of the textile materials is achieved by the chemical modification induced by CORONA discharge, enlarging the field of advantages of this technology to finishing treatments such as, among others, softening, anti-shrinking, easy-care, fireproofing and to the fixation of the printing pastes with pigments by binders. The application of finishing baths to materials treated with CORONA also guarantees higher uniformity and hidrophility of finished products.

### REFERENCES

[1] Thorsen, W. J.; Landwehr, R. C., “A Corona-Discharge Method of Producing Shrink-Resistant Wool and Mohair”, Textile Research Journal, Agosto, 1970.
[2] Carr, C., Dodd, K., “The effect of Corona Treatment on the Hygral Expansion of Wool Worsted Fabrics”, J. Soc. Dyers Colourists 110, December, 1994.
[3] Belleli, Tino, “La laine sous traitments plasma”, L'Industrie Textile, No. 1287, Mai, 1997.
[4] Thorsen, W. J., Improvement of Cotton Spinnability, Strength, and Abrasion Resistance by Corona Treatment”, Textile Research Journal, Maio, 1971.
[5] Chen, J., “Study on Free Radicals of Cotton and Wool Fibres Treated with Low-Temperature Plasma”, J. of Applied Polymers Science 62, 1996.
[6] Marimba, A.; Carneiro, N.; Souto, A. P., “Tratamentos Plasma e Corona sobre Materiais Têxteis”, Nova Têxtil, No. 47, Janeiro, 1998.
[7] Carneiro, N.; Souto, A. P.; Silva, E.; Marimba, A.; Tena, B.; Ferreira, H.; Magalhães, V., “Dyeability of Corona Treated Fabrics”, Coloration Technology, Society of Dyers and Colourists, No. 117, 2001.

1-8. (canceled)

9. A method for the non-polluting treatment of a cellulosic material comprising the steps of:
a. moving the cellulosics material between an electrode and a counter electrode;
b. applying a sinusoidal electric discharge between the electrode and the counter-electrode, maintaining a difference in potential of between 5000 and 30000 volts, wherein the electrode and counter electrode comprise a dielectric barrier; and
c. cooling the electrode and counter electrode,
thereby using Corona discharge causing oxidation and hydrophilisation and increase in the reticulation potential of the cellulosic materials.

10. The method of claim 9, whereby the cellulosic material is textile.

11. The method of claim 9, whereby the difference potential is between 10000 and 15000 volts.

12. The method of claim 9, whereby the step of moving is continuous or semi-continuous.

13. The method of claim 9, whereby the sinusoidal electric discharge is at a frequency range of between 10 and 100 kHz.

14. The method of claim 13, whereby the sinusoidal electric discharge is at a frequency of 30 kHz.

15. The method of claim 9, resulting in complete and uniform wetting during impregnation and a higher adhesion of resins and binders.

16. The method of claim 9, whereby the treatment is desizing, scouring, bleaching, caustification, mercerization, dyeing, printing or finishing.

17. The method of claim 16, whereby in the step of applying, the sinusoidal discharge is effected on open-width fabric at a controlled temperature, griege, humidity and velocity.

18. The method of claim 10, whereby the textile is selected from the group consisting of cotton, flax, hemp and their blends with synthetic or artificial fibres, providing that the cellulosic component has the highest percentage in the blend.

19. A chamber for the treatment of a textile material comprising:
a. an electrode with plurality of bars and a rotating counter-electrode, said electrode and counter electrode comprising a dielectric barrier;
b. a gas distribution compartment for the cooling of the electrode, disposed between the bars comprising the electrode; and
c. a gas outlet.

20. The chamber of claim 19, wherein said gas distribution compartment has openings in order to permit a uniform distribution along the electrode bars.

21. The chamber of claim 19, wherein the electrode comprises ceramic material and is separated from the counter-electrode by a distance of between 0.8 mm and 3 mm.

22. The chamber of claim 21, wherein the electrode is separated from the counter-electrode by a distance of 1.5 mm.

23. The chamber of claim 19, wherein it is possible to adjust the distance by moving the electrode consisting of bars and the cooling gas distribution compartment or the counter-electrode or both.

24. The chamber of claim 19, wherein the counter-electrode is a rotating drum coated with a dielectric barrier, which carries the textile material.

25. The chamber of claim 24, wherein the dielectric barrier is made of silicone or ceramic material.

26. The chamber of claim 24, wherein the rotating drum has a double skin drum capable of being temperature controlled.

27. The chamber of claim 26, wherein the temperature control is done using a liquid medium.

28. The chamber of claim 19, wherein the number and type of electrodes used depend on the velocity of the textile material.

29. The chamber of claim 28, wherein only one side of the textile material is treated.

30. The chamber of claim 28, wherein both sides of the textile material are treated.
